(19) United States
(12) Patent Application Publication
(10) Pub. No.: US 2024/0401706 A1
(43) Pub. Date: Dec. 5, 2024

(54) PINCH CONTROL VALVE

(71) Applicant: VERDOT IPS2, Parc EERA (FR)

(72) Inventors: Sebastien Robert LEFEBVRE, Parc EERA (FR); Kevin GOUT, Parc EERA (FR); Philippe VERNOT, Parc EERA (FR)

(21) Appl. No.: 18/699,025

(22) PCT Filed: Oct. 7, 2022
(86) PCT No.: PCT/IB2022/059587

§ 371 Date: Apr. 5, 2024

(30) Foreign Application Priority Data
Oct. 18, 2021 (FR) FR2111060

(51) Int. Cl. F16K 7/06; F16K 7/04

(52) U.S. Cl. CPC F16K 7/065; F16K 7/045

(57) ABSTRACT

A pressure control pinch valve for a flexible tube, includes a fixed support cooperating with one side of a flexible tube to be controlled, a dynamic pressure arranged on the opposite side to the fixed support and able to pinch the tube in order to control the pressure therein, the dynamic pressure being composed of a rotating roller that is mounted so as to rotate about an off-center axis with respect to the center of the roller and is provided with a peripheral contact surface exerting a force directly on the tube.

### CROSS-REFERENCE TO RELATED APPLICATION(S)

This is a National Stage Entry into the United States Patent and Trademark Office from International Patent Application No. PCT/IB2022/059587, filed on Oct. 7, 2022, which relies on and claims priority to French Patent Application No. 2111060, filed on Oct. 18, 2021, the entire contents of both of which are incorporated herein by reference.

### FIELD OF THE INVENTION

The present invention relates to a pressure control pinch valve for flexible tube comprising a fixed support working in conjunction with one side of a flexible tube to be controlled, with a dynamic pressure applied on the side opposite to the fixed support and capable of pinching the tube to control the pressure.

### BACKGROUND OF THE INVENTION

In the prior state of the art, such as patents US2020/096120 A1 and US2020/282361 A1, pinch valves are designed with a linear actuator to control the back pressure. In all these embodiments, the axis of the linear actuator is perpendicular to the axis of the flexible tube. The linear actuator consists of a plunger which compresses the tube against a fixed support on the opposite side.

These solutions suffer from the fact that the loss of load exerted by the pinch valve is not proportional to the pinch height. In practice, the range of pinch heights in which the back pressure can be controlled is very narrow, especially with low flow rates when the tube must be almost closed to cause a loss of load.

Another drawback of these solutions is the small width of the plunger. These valves are generally derived from pinch valves designed to close the tube for isolation purposes. The plunger is therefore narrow to minimize the force required to shut off the tube, and hence to minimize the linear actuation power. However, to achieve a gradual decrease in pressure such as is necessary for a control valve, it is preferable to pinch the tube over a larger surface so that the pressure drop is greater for a given pinch height.

The document GB2274326I describes a pinch valve comprising a cam 38 and a cam follower 39 pinching a flexible tube 42. On the other side, the tube is held by a bearing surface adjustable according to the diameter of the tube. The cam/cam follower system is complex and imprecise and therefore unsuitable for precision control.

The document EP2908902 describes a flow control valve in a medical injection device. The flow through the tube is controlled by a cam that can act against one side of the tube. On the other side of the tube, a pinching element presses the tube against the cam. The profile of the pinching element is relatively sharp to enable the flow in the tube to be stopped.

The document US2003/127613 also describes a flow regulating valve, using tube compressing elements. The compressing elements are rounded and of small dimensions compared with the tube, which prevents fine and precise control.

To address these various drawbacks, the invention provides various technical means.

### SUMMARY OF THE INVENTION

A first objective of this invention is to provide a pressure control valve that will enable high precision control for a wide range of pressures.

Another objective of the invention is to provide a reliable pressure control valve at a moderate cost.

Another objective of the invention is to provide a tangential flow filtration system with precise and reliable pressure control.

To do this, the invention provides a pressure control pinch valve for flexible tube comprising a fixed support working in conjunction with one side of a flexible tube to be controlled, a dynamic pressure arranged on the side opposite the fixed support and capable of pinching the tube to control the pressure, the dynamic pressure being provided by a roller rotating around an axis which is eccentric to the center of the roller and provided with a peripheral contact surface exerting a force directly on the tube so as to gradually compress the tube against the fixed support during a rotation of the roller in the compression direction and gradually open the tube during a rotation in the release direction, the fixed support comprising an active surface capable of compressing the tube, said active surface being plane or concave with a width Lar equal to or greater than 1.4 times the external diameter DE of the tube at rest.

When the roller is turned in the compression direction (with increase in the angle α), the roller compresses the tube and increases the loss of load in the circuit. When the roller is turned in the release direction (with decrease in the angle α), the roller releases the tube, which resumes its shape enabling a decrease in the loss of load in the circuit. This system is simple, reliable, enables very fine adjustments and is easily interchangeable. The minimum width Lar of the active surface is that of the width of the tube in compressed position.

The proposed architecture comprises a one-piece means of pinching, with direct contact of the roller without the use of an intermediate part, contributing to a simplified and reliable product architecture. The means of pinching uses an eccentric roller enabling the pressure to be controlled with high precision. This architecture facilitates the interchangeability of parts in order to use various diameters of tube with the same device.

Such an arrangement enables gradual pinching or compressing of the flexible tube, ensuring precise and reliable control. The use of a roller with large dimensions relative to the tube increases the pinched length of tube, thereby enabling a greater pressure drop for a given pinching height compared with a narrow plunger. To this effect, the roller is advantageously dimensioned to act on at least the whole width of the tube.

Advantageously, the minimum flat length Lminflat or concave length Lminconc of the active surface is that of the length of tube in contact with the roller when the latter is at an angle of rotation α of 180°.

According to one advantageous embodiment, the roller is rotated by an electric motor, preferably a step motor, with or without a gearbox between the motor and the rotating roller. In another variant, a brushless motor drive can be provided with absolute or relative position coder. This enables automation of the control with fine adjustment.

When the gearbox is placed between the motor and the rotating roller, this enables the angle of the eccentric roller at the output of the gearbox to be converted to a larger angle or into several rotations at the input of the gearbox where the roller is actuated. The angular precision of the roller is thus multiplied by the transmission ratio to control the angle α of the eccentric roller.

Advantageously, the control valve comprises a rotating coupling between the rotating roller and the rotation axis with teeth radial to the axis of rotation. A Hirth type coupling can also be used. Such couplings reduce or eliminate angular play of the angle α that would affect the control precision. Such arrangements further provide great simplicity of assembly, enabling rollers to be quickly changed for use with various tube diameters.

Advantageously, the roller comprises an external cage mounted in free rotation relative to the roller. The external cage can thus rotate freely so that when the eccentric core of the roller rotates, the external cage does not slide along the tube. This prevents wear of the tube and sideways movement of the tube along its axis.

The invention also comprises a pressure control system comprising a control valve as previously described and a flexible tube to be controlled, in which the tube is elastically deformable and resumes its shape after compression and release of the pinching force.

Advantageously, the roller is eccentric at a distance d-ex of 0.5×(1−K2)×internal diameter of tube+K1×the tube wall thickness, and the distance “D” between the effective axis of rotation of the roller (5) and the fixed support (2) is 0.5×[external diameter of the roller+(1−K2)×internal diameter of the tube]+[2−K1]×the tube wall thickness, where K1, with no units, is the compression factor of the walls of the tube when the pinch height “P” is minimum and is between 0.05 and 0.15 and K2, with no units, representing the degree of closure of the tube when the angle is 0°, is between 0 and 0.15.

When the pump is controlled to supply a constant flow, the control valve can advantageously be used to control the pressure downstream of the pump. The control valve is then set to closed loop with pressure measurement between the pump and the control valve.

The invention also provides a tangential flow filtration system comprising a membrane filter, a pump for injecting a mixture to be filtered in the membrane filter, a back pressure control valve in fluid cooperation with the output of the membrane filter, and a recirculation tank connected between the back pressure control valve and the pump, in which the back pressure control valve is a pinch control valve as previously described.

Advantageously, the filtration system comprises a closed loop control circuit with pressure measurement upstream of the control valve to obtain a set pressure where the pressure is measured.

Also advantageously, the set point and control feedback is a differential pressure.

The differential pressure is preferably a transmembrane pressure of a tangential flow filtration filter medium, the transmembrane pressure TMP being the average pressure of the retentate less the pressure Pp of the permeate, the “permeate” being the fraction of the mixture to be filtered that passes through the membrane, the remaining fraction, the “retentate”, being recycled in the recirculation tank.

This arrangement enables closed loop control with pressure feedback, possibly integrating the flow rate for enhanced control.

In the advantageous case when the pump is controlled to supply a constant pressure, the control valve can advantageously be used to control the pressure downstream of the pump. The control valve is then set to closed loop with pressure measurement between the pump and the control valve.

### BRIEF DESCRIPTION OF THE DRAWINGS

All the embodiment details are given in the description which follows, completed by FIGS. 1 to 11 shown simply as non-limiting examples, and in which:

FIG. 1 is a perspective view showing an example of a control valve;

FIG. 2 is a cross-sectional view of the control valve of FIG. 1;

FIG. 3 is a schematic representation of the concept of decentering of the control valve roller in order to act by pinching the flexible tube to control the pressure, here with the roller positioned at 0°;

FIG. 4 is a schematic representation of the concept of decentering of the control valve roller in order to act by pinching the flexible tube to control the pressure, here with the roller positioned between 0° and 180° causing the tube to be pinched with restriction of the flow;

FIG. 5 is a schematic representation of the concept of decentering of the control valve roller in order to act by pinching the flexible tube to control the pressure, here with the roller at 180° causing the tube to be compressed and the flow stopped;

FIG. 6 is a graph illustrating the effect on pressure of pinching the tube;

FIG. 7 is a schematic representation of an example of a tangential flow filtration system;

FIG. 8 is a schematic representation of an example of automatic control using a pinch control valve;

FIG. 9 shows an exploded view of the control valve of FIG. 1.

FIG. 10 is a schematic representation similar to that of FIG. 5, with the roller at 180°, and illustrating the minimum length of an active plane surface;

FIG. 11 is a schematic representation similar to that of FIG. 5, with the roller at 180°, and illustrating the minimum length of an active concave surface.

### DETAILED DESCRIPTION OF THE INVENTION

### Control Difficulties

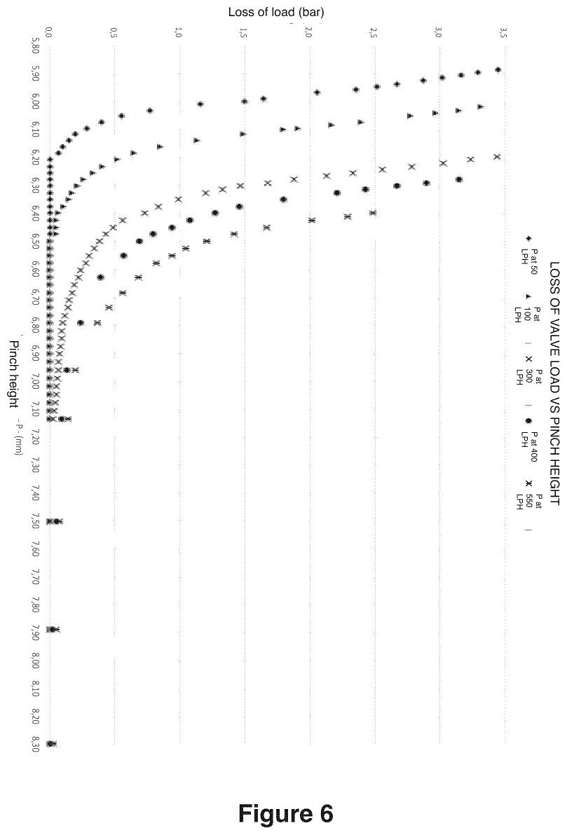

To illustrate the difficulties related to control, the graph of FIG. 6 shows the back pressure of a pinch valve as a function of the pinch height and flow rate. In this example, the tubing is designed for a flow range of 20 to 600 LPH for a target back pressure control between 0.2 and 3 bar. These values depend on the design of the pinch valve and the tube chosen.

Several observations can be made from this graph, applicable to any type of pinch valve. The first is that the lower the flow rate, the narrower the pinch height range in which the required range of back pressure can be obtained. For example, in the example in a box of FIG. 6, the back pressure of the valve increases by 1 bar with only 53 μm height variation when functioning at 50 LPH or 100 LPH, in the range, therefore, of low flow rates.

The second observation that can be made from this graph is the following: in the high pressure range, where the tube has to be highly pinched, a slight change in pinch height induces a large variation in back pressure. From these observations, we can deduce that very high precision is required in the actuator to control the pinch height, especially in the range near to complete closure of the tube. A precision of the order of μm is necessary in the pinch height to control a pressure variation of the order of 0.1 bar.

### Definitions

By “back pressure control valve” is meant a valve with controlled opening that adjusts to the set pressure the pressure at its fluid inlet orifice supplied at a constant flow rate, usually by adjustment of a pump upstream of the valve. The valve opening is increased to reduce the loss of load caused by this valve when the inlet pressure exceeds the pressure set point. The valve opening is decreased to increase the loss of load caused by this valve when the inlet pressure is below the pressure set point.

“LPH” means a flow rate measured in liters per hour.

“BPCV” is the abbreviation of Back Pressure Control Valve.

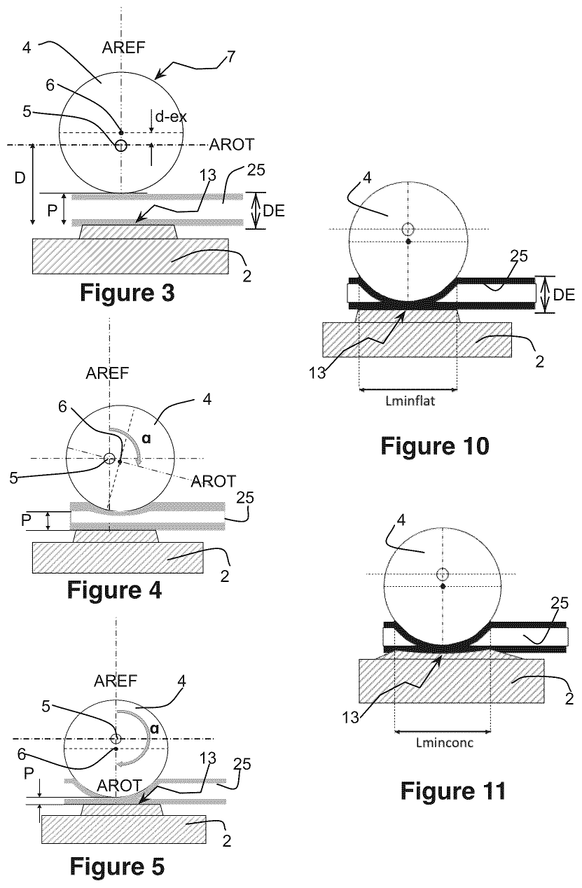

By “angle” or “roller angle” is meant all the angles with reference to the angle of rotation of the eccentric roller, as shown in FIGS. 3, 4 and 5 by the symbol a. An angle being defined by two axes, namely a reference axis AREF and an axis of rotation AROT, and a point of intersection of the two axes. The point of intersection is the effective axis of rotation 5 of the eccentric roller, represented in FIG. 3 by an empty circle. The reference axis AREF is the line perpendicular to the axis of the flexible tube 25 passing through the effective axis of rotation 5 of the eccentric roller. The axis of rotation is defined by the line passing through the axis of rotation and the eccentric axis of the roller, represented in FIGS. 3 to 5 by a small black disk.

By “TMP” is meant the transmembrane pressure.

Control Valve with Roller

The present invention proposes a new concept for back pressure control valves designed for all types of flexible tube, insofar as the tube remains elastic when it is completely pinched, i.e. it returns substantially to its initial opening when it is released. The concept applies at least for back pressures from 1 bar absolute to 30 bars absolute. The concept is compatible with any fluid in the gas or liquid phase and to any fluid treatment.

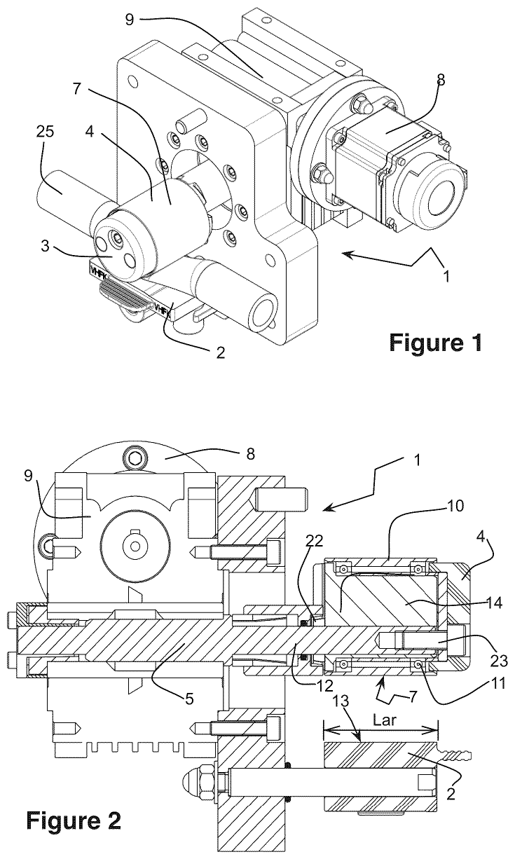

As shown in FIG. 1, which is an example of an embodiment and in FIGS. 3 to 5, the principle of the invention is to pinch a flexible tube 25 between a fixed support 2 and an eccentric roller 4 rotated over a half turn by an electric motor 8 or a rotary actuator with or without intermediate gearbox 9.

In the examples illustrated, the roller 4 has a circular external profile such that its “natural” axis of rotation lies at the center 6 of the roller. Since the roller 4 is eccentric, its actual or effective axis of rotation 5 is offset by a distance “d-ex” corresponding to the off-centering of the effective axis of rotation 5 with respect to the center 6 of the roller. As a variant, when the external profile of the roller is not circular in shape, the center 6 is the geometric center of the profile concerned.

As shown in FIG. 3, the off-centering “d-ex” of the eccentric roller 4 and the distance “D” between the effective axis of rotation 5 of the roller and the fixed support 2 are adapted to the tubing 25 so that at an angle of rotation of 0°, the pinch height “P” between the roller and the fixed support is sufficient to easily fit the flexible tubing with a certain play or requiring slight compression as shown in FIG. 4, and at an angle of rotation of 180°, the tubing is completely closed as shown in FIG. 5. The back pressure is controlled with an intermediate angle between 0° and 180° as in the example of FIG. 4.

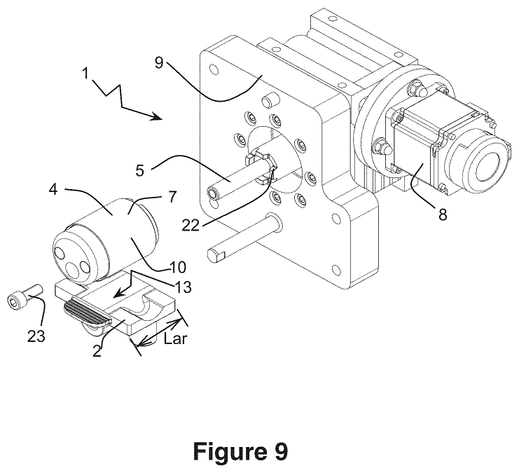

FIG. 2 gives extra details of FIG. 1 with a vertical cross-sectional view along the axis of the roller 4. It thus provides more details on the internal design of the roller. In this example of embodiment, the axis of rotation 5 of the roller is given by the output shaft 12 of the gearbox. As shown in FIGS. 2 and 9, this is equipped with a coupling with radial teeth 22, fixed by a shrink disk on the axis of rotation to couple its rotation with the eccentric core 14 of the roller which is also provided with teeth meshing with the teeth 22 so that the two parts fit together with no play when compressed together by the front screw 23.

The gearbox 9 is chosen with low angular play or with no play. The axis of rotation 5 and the gearbox 9 are coupled in rotation by a shrink disk. Finally, the roller and the axis of rotation are coupled with teeth radial with respect to the axis of rotation, or with a Hirth type coupling. This coupling with radial teeth eliminates any angular play when assembling with the front screw. It thus provides angular precision and simplicity of assembly, enabling rollers to be quickly changed for use with various tube diameters.

However, any other solution available on the market for rotating coupling is possible. The eccentric core 14 of the roller is a cylinder whose axis is off-centered with respect to the rotation shaft 12. The off-centering is shown by the dimension “d-ex” in FIG. 3.

The roller 4 and the fixed support 2 are dimensional parts that may be exchanged to adapt to various sizes of tube. As illustrated in particular in FIGS. 10 and 11, the fixed support 2 comprises an active surface 13 that can work in conjunction with a tube 25 to compress it. This active surface 13 is preferably flat as shown in the example of FIG. 10. As a variant, it is concave as shown in the example of FIG. 11. With these two shapes, the length of tube compressed under the roller can be greater, and hence the angle of rotation exerting a loss of load on the tube, enabling a more gradual control of the pressure.

The active surface 13 comprises a minimum length. In the case of a flat active surface, illustrated in FIG. 10, the flat minimum length (Lminflat) is the length of the tube 25 in contact with the roller 4 when the latter is at an angle of rotation α of 180°. In the case of a flat concave active surface, illustrated in FIG. 11, the flat minimum length (Lminconc) is also the length of the tube 25 in contact with the roller 4 when the latter is at an angle of rotation α of 180°. This length depends on the coefficients K1, K2 of the thickness of the tube and the diameter of the roller, and the radius of any concavity.

The active surface 13 comprises a width “Lar” equal to or greater than 1.4 times the external diameter DE of the tube 25 when the latter is at rest, without any compression.

The same valve can therefore be used optimally with different orders of flow rate. The radial teeth enable coupling without play, once tightened, unlike other solutions such as a locking pin which would require very precise adjustment and therefore be difficult to fit to reduce play in rotation.

The eccentric core 14 of the roller is equipped on the exterior with spacers and bearings 11 fitted tightly together along the axis of rotation with washers and screws. The bearings 11 are housed in the recess of the external cage 10. The external cage can thus rotate freely so that when the eccentric core of the roller rotates, the external cage 10 does not slide along the tube 25. This prevents wear of the tube and sideways movement of the tube along its axis. The implementations with roller, spacers and washers are only considered as examples for the free rotation around the eccentric core of the roller. Other alternatives with plain bearings in plastic or needle bearings can also be used for a more compact design. A simpler design without free rotation may also be used, for example with the eccentric core of the roller directly in contact with the flexible tube, if the latter can withstand the friction of the eccentric core of the roller for its lifetime.

Other implementations are possible with a different shaft coupling or another type of gearbox, or without gearbox, hence with a rotary actuator directly coupled to the eccentric core of the roller. The important thing is that the angular precision of the control actuator, or handwheel if it is manual, be sufficiently high and that the angular play of the gearbox and coupling with the roller be sufficiently small for the angular error not to cause more fluctuation than acceptable in the control of the BPCV.

According to the precision required in back pressure control, of the pressure range, the various calculations of off-centering “d-ex”, of distance “D” can be used. In the following sections, several examples will be explained.

In general, the off-centering “d-ex” of the eccentric roller and the height “D” are calculated as being:

Off-centering “d-ex”=0.5×(1−K2)×internal diameter of the tube+K1×thickness of the tube wall.

Height “D”=0.5×[external diameter of the roller+(1−K2)×internal diameter of the tube]+[2−K1]×thickness of the tube wall.

K1, without units, is the compression factor of the walls of the tube when the pinch height “P” is a minimum, i.e. when the angle is 180°. If a low value of K1 is chosen, such as 0.05, the tube is slightly compressed when the angle of the eccentric roller is 180°. In this position, the tube may not be sufficiently sealed to act as an isolation valve. However, a small value of K1 positions the angular range where the tube is most pinched closer to 180°. This is where high precision is necessary. Since the pinch height “P” results from the cosine of the angle, when the angle approaches 180°, the variation in angle causes a much smaller variation in the pinch height than if the angle were in a lower range. Consequently, for a value K1 between 0.05 and 0.15, the rotary actuator provides a finer control of pinch height within this range where there is a high variation in pressure. The coefficient of 0.15 allows for the compression of the tube thickness under pressure.

If a higher value of K1 is chosen, such as 0.25, most tubes can be sealed when the eccentric roller is turned to 180°. The valve controlled by the back pressure can therefore be used as an isolation valve. However, this positions the angular range where the tube is most pinched within smaller angles. An angular variation brings with it a greater variation in pinch height. The control sensitivity is thus not as great as in the preceding example. K1 can also be chosen in the negative range, such as −0.05 so as to position the angular range where the tube is most pinched still closer to 180° compared with the first example, and therefore to gain a little more precision. However, the manufacturing tolerance of the thickness of the flexible tube wall must be taken into account so that in the worst case, if the thickness of the wall is in the lower range of tolerance, the pinching is sufficient to obtain the desired back pressure.

K2, without units, is the degree of closure of the tube when the angle is 0°. If K2 is chosen equal to 0, the pinch height “P” is the external diameter of the tube when the angle is 0°. This facilitates the fitting of the tube in the valve.

To maximize the precision of the pressure controller, without compromising the flow rate range of the pressure control valve, it may be useful to choose a value of K2 between 0 and 0.15 to reconcile the ease of fitting the tube between the roller and the active surface, and to reduce the required eccentricity and hence enable finer control of the pressure. This requires the tube to be slightly pinched when the roller is at the angle 0°, but a 5% compression of the tube is not difficult to obtain and it remains easy to fit the tube. Similarly, the example of FIG. 6 shows that no pressure drop is obtained with a pinch height of 8.90 corresponding to a compression of 5% of the tube with an internal diameter of 9.4 mm. This therefore does not increase the flow channel back pressure at an angle of 0° when the back pressure is unnecessary. However, the above formulas show that a positive value of K2 tends to reduce the eccentricity. Since the variation in pinch height “P” is proportional to the eccentricity “d-ex”: with a positive value of K2, the variation in angle results in a smaller variation of pinch height “P”, hence a greater control precision whatever the angle. K2 can also be chosen with a negative value such as −0.05. In this case, with the roller at 0°, the pinch height “P” is greater than the external diameter of the tube, therefore making it easier to fit the latter, or to allow the use of a larger tube. But it is easy to deduce that there results a lower precision in the pinch height “P”.

### Example of Application of the Control Valve

The present invention can be applied to any fluid application handling liquid or gas requiring control of the back pressure in a flexible tube.

Many processes for treating fluids require a back pressure control valve “BPCV” to maintain a fixed and stable pressure in the circuit upstream of the BPCV in order to ensure that the process functions properly while a liquid or gas flows in the tubing. Examples of applications include process chromatography, tangential flow filtration.

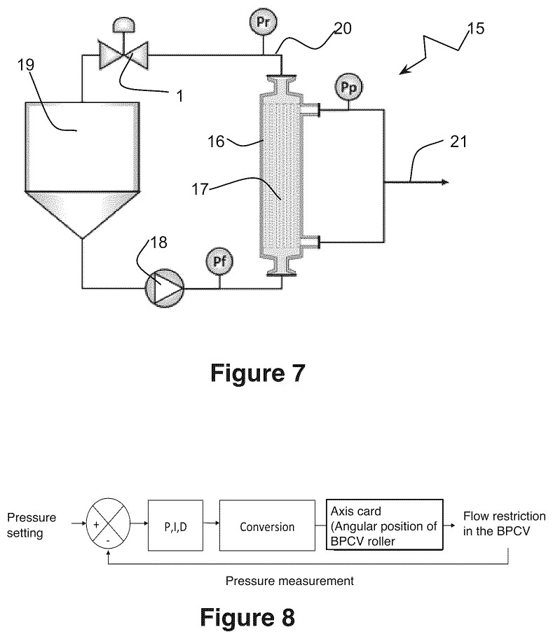

Tangential flow filtration requires highly precise control of the transmembrane pressure “TMP”, as illustrated schematically in FIG. 7. Membrane filtration is a separation technique in which a product to filter circulates under pressure, usually applied by a pump 18, through the semi-permeable membrane 17 of a filter 16. The fraction that passes through the membrane is called the “permeate” 21. The retained fraction, the “retentate” 20 is recycled in a recirculation tank 19. For the filtration to be optimal, a stable pressure difference called transmembrane pressure must be exerted on the filtration membrane 17. The transmembrane pressure is calculated as the average pressure of the retentate less the permeate pressure (Pp). The average pressure of the retentate is the average of the pressure measured at the outlet orifice of the retentate (Pr) and the measured pressure P in the inlet orifice of the retentate (Pf). Thus, TMP=(Pr+Pf)/2−Pp, all these parameters being measured with the same pressure unit (bar, Pascal, PSI, or other). By adjusting the opening of the BPCV, the TMP can be adjusted around its set value. Thus, in all, the TMP used as set point and as feedback to control the BPCV, can be calculated from three pressure measurements (Pr, Pf, Pp).

In the case of a simple application requiring a manually controlled fixed pressure, the control mechanism is generally a diaphragm or a piston with spring to adjust the fluid opening. This can be covered in the present invention by a handwheel in place of the electric motor or the rotary actuator of FIG. 1. However, the present invention is intended mainly for automated systems in which the pressure setting is defined by an electronic control system. In this case, the opening of the valve is controlled by an electrical actuator which is electronically closed-loop controlled using a pressure measurement upstream of the valve as feedback. The pressure can be measured just upstream of the valve, or a more complex measurement may be used such as the transmembrane pressure in the case of tangential filtration.

As an alternative to solutions using a rigid plastic or steel tube, many devices today are designed with flexible tubes made of elastomers such as silicone, PVC, PTFE or other flexible materials which may be given external textile or metallic reinforcement to better withstand pressure. These solutions are being increasingly used for so-called “single use” procedures in the pharmaceutical industry, where all the tubing and equipment, i.e. all surfaces in contact with the product, is replaced at the end of the production cycles, batches or product changes to prevent cross-contamination.

### Loop Control

The following section concerns the electronic control of the BPCV. The purpose of the motor 8 or rotary actuator of the BPCV is to position the angle of the eccentric roller precisely and rapidly as a function of the pressure measured upstream of the BPCV in order to obtain the set pressure.

This can be summarized by FIG. 8, which shows a standard closed loop control flowchart. The term “PID” designates proportional integral derivative controller, commonly used in closed loop control.

The BPCV controller controls the start of the loop: it receives the pressure setting which it compares with the measured pressure (simple or complex as previously indicated). The difference between the pressure setting and the pressure measurement serves as entry point for the control, using the PID control parameters and resulting in a pinch “P” correction (0%=minimum pinch, 100%=maximum pinch). The axis drive then proceeds to adjust the angle of the eccentric roller in accordance with this pinch correction.

There are several control solutions, from the simplest, but less effective, to a more complex control taking into account the fluid flow rate for a better BPCV performance. In the case of the simplest solution: the control is applied over the whole BPCV stroke, i.e.: from 0° to 180°, whatever the flow rate. In the case of a low flow rate and a high set pressure, where the angle has to be pushed up to 180°, and if the control begins with the valve completely open, hence with the eccentric roller at 0°, there can be a long interval before the BPCV reaches the appropriate angle, during which time the control may accelerate the rotation speed, thereby causing too rapid a variation in pressure when the correct angle is reached. The control must therefore be slow to avoid a pressure excess.

A more effective, but more complex solution may be used, consisting in adjusting the BPCV angular control range to the current flow rate. This requires the flow rate to be measured or the control of the current flow rate to be informed. The BPCV control acts over a limited angular range. The smallest angle is calculated to provide the minimum pinch height where no back pressure is now exerted by the BPCV on the current flow rate. For example, in FIG. 4, if the flow rate is 100 LPH, the smallest angle has to provide a pinch height of 6.5 mm (8). The largest controlled angle is chosen to supply the maximum allowed pressure to the given flow rate. For example, in FIG. 6, if the flow rate is 100 LPH and the maximum allowed pressure is 3.3 bar, the largest angle has to provide a pinch height of 6.00 mm. Integrating the flow rate in the control enables a shorter response time which is coherent with the BPCV control whatever the flow rate.

1. A pressure control pinch valve for flexible tube comprising a fixed support working in conjunction with one side of a flexible tube to be controlled, a dynamic pressure arranged on the side opposite the fixed support and capable of pinching the tube to control the pressure, the dynamic pressure being provided by a roller rotating around an axis which is eccentric to the center of the roller and provided with a peripheral contact surface exerting a force directly on the tube so as to gradually compress the tube against the fixed support during a rotation of the roller in the clamping direction and gradually open the tube during a rotation in the release direction, characterized by the fixed support comprising an active surface capable of compressing the tube, said active surface being plane or concave with a width (Lar) equal to or greater than 1.4 times the external diameter DE of the tube at rest.

2. The pressure control pinch valve according to claim 1, wherein the minimum flat length (Lminflat) or concave length (Lminconc) of the active surface is that of the length of tube in contact with the roller when the latter is at an angle of rotation α of 180°.

3. The pressure control pinch valve according to claim 1, wherein the roller is rotated by an electric motor, with or without gearbox placed between the motor and the rotating roller.

4. The pressure control pinch valve according to claim 1, wherein the roller comprises an exterior cage mounted in free rotation with respect to the roller.

5. The pressure control pinch valve according to claim 1, comprising a rotating coupling between the rotating roller and the rotation axis with teeth radial to the axis of rotation.

6. A pressure control system comprising a control valve according to claim 1, and a flexible tube to be controlled, wherein the tube is elastically deformable and resumes its shape after compression and release of the pinching force.

7. The pressure control system according to claim 6, wherein the roller is eccentric at a distance d-ex of 0.5×(1−K2)×internal diameter of tube+K1×the tube wall thickness, and the distance “D” between the effective axis of rotation of the roller and the fixed support is 0.5×[external diameter of the roller+(1−K2)×internal diameter of the tube]+[2−K1]×the tube wall thickness, where K1, with no units, is the compression factor of the walls of the tube when the pinch height “P” is minimum and is between 0.05 and 0.15 and K2, with no units, being the degree of closure of the tube when the angle is 0°, is between 0 and 0.15.

8. A tangential filtration system comprising a membrane filter, a pump for injecting a mixture to be filtered in the membrane filter, a back pressure control valve in fluid cooperation with the output of the membrane filter, and a recirculation tank connected between the back pressure control valve and the pump, wherein the back pressure control valve is a pinch control valve according to claim 1.

9. The tangential filtration system according to claim 8, comprising a closed loop control circuit with pressure measurement upstream of the control valve to obtain the set pressure where the pressure is measured.

10. The tangential filtration system according to claim 9, wherein the set point and control feedback is a differential pressure corresponding to a transmembrane pressure of a tangential flow filtration filter medium, the transmembrane pressure TMP being the average pressure of the retentate less the pressure Pp of the permeate, the “permeate” being the fraction of the mixture to be filtered that passes through the membrane, the remaining fraction, the “retentate” being recycled in the recirculation tank.

11. The tangential filtration system according to claim 8, wherein the pump is adjusted to supply a constant pressure, the control valve being capable of controlling the pressure downstream of the pump.
